(19) United States
(12) Patent Application Publication
(10) Pub. No.: US 2025/0150390 A1
(43) Pub. Date: May 8, 2025

(54) MECHANISMS FOR COMMUNICATION WITH A SERVICE ACCESSIBLE VIA A TELECOMMUNICATION NETWORK TAKING INTO ACCOUNT THE MOBILITY OF SERVICES, USERS AND EQUIPMENT

(71) Applicants: Université de Bordeaux, BORDEAUX (FR); Institut Polytechnique de Bordeaux, TALENCE (FR); Centre National de la Recherche Scientifique, PARIS (FR)

(72) Inventor: Damien MAGONI, Saint-Caprais-de-Bordeaux (FR)

(21) Appl. No.: 18/721,189

(22) PCT Filed: Dec. 11, 2022
(86) PCT No.: PCT/FR2022/052308

§ 371 Date: Jan. 14, 2025

(30) Foreign Application Priority Data
Dec. 17, 2021 (FR) FR2113781

(51) Int. Cl. H04L 45/586; H04L 45/64; H04W 60/00

(52) U.S. Cl. CPC H04L 45/586; H04L 45/64; H04W 60/00

(57) ABSTRACT

The invention relates to a method for establishing communication between a user and a service, implemented by at least one server, by means of a telecommunication network, which method comprises:—registering the service, comprising the creation of a virtual overlay network for said service over said telecommunication network, and assigning and storing identifiers and a virtual address for this service and for this server; —registering the user with the service and with the virtual overlay network, comprising logging into a web interface suitable for triggering the assignment of a user identifier, as well as connecting a terminal used by the user, triggering the assignment and storage of an identifier and a virtual address of this terminal; and—routing data packets between the user and the service via a virtual connection established within the virtual overlay network on the basis of these virtual addresses.

### FIELD OF THE INVENTION

The present invention relates to securing communication over communication networks between entities such as users and services. It particularly applies to managing Internet communication between users and sensitive services such as commercial, banking, health-related and administrative services, etc.

### BACKGROUND OF THE INVENTION

Internet-based communications are generally still based on a paradigm built up some forty years ago around the TCP/IP protocol stack. In this paradigm, pieces of equipment are assigned IP addresses enabling it to communicate with other equipment connected to the Internet.

Although mechanisms have been proposed to manage mobility, security and multicasting, they are still based on the idea of machine-to-machine communication. These mechanisms are aimed at layer 2 of the OSI model and allow certain types of mobility between WLAN (e.g., IEEE 802.11 family), cellular (e.g., 2G to 5G) and vehicular (e.g., IEEE 1609 and 802.11p) networks, but do not allow mobility to be managed properly at the higher layers of the OSI model, and in particular at layer 3, as demonstrated by the failure of the MobileIP protocol to be deployed.

These mechanisms do not enable complete mobility, which means transferring communication from one piece of equipment to another without interrupting the current communication to start a new communication. Similarly, while a user may have a plurality of applications available on his equipment, it is not currently possible to transfer communication from one application to another.

Additionally, for secure communications, current security mechanisms such as TLS, DTLS and IPsec, are based on equipment IP addresses, or on the domain names associated with these addresses, in order to generate secret session keys for encrypting communications. As a result, when equipment is changed or moved from one access network to another, the IP address is modified, and the security process has to be reinitialized on the basis of the new address, resulting in a discontinuity of the service provided to the user and impacting the perceived quality of service (QOS).

It therefore appears that the prior art is insufficient to provide a communication mechanism that enables total mobility of equipment, services and users, moreover in a totally secure way.

### SUMMARY OF THE INVENTION

The present invention aims to provide a solution that at least partially overcome the aforementioned drawbacks.

It particularly aims to improve connectivity (that is, the way in which end-to-end data packets are routed) between one (or more) users and a service.

More specifically, according to embodiments, it aims to provide a method and an architecture enabling users and services to move from one equipment to another, and enabling equipment to modify its connection to the network, without impacting either the maintenance of the connection between the user and the service, or the security of the connection.

To this end, the invention aims to change the usual paradigm of connectivity based on network layer addresses (e.g. IP addresses) assigned to equipment for connectivity based on identifiers assigned to users and services, which are independent of the IP addresses of the equipment on which they are deployed.

To this end, according to a first aspect, the present invention can be implemented by a method for establishing communication between a user and a service implemented by at least one server, by means of a telecommunication network, comprising
registering said service comprising the creation of a virtual overlay network for said service, over said telecommunication network, assigning a service identifier, a server identifier and a virtual address for the server within said virtual overlay network, and storing an association between said service identifier and said server identifier and an association between said server identifier and said virtual address for the server, within a hash table distributed over nodes of said virtual overlay network;
registering said user with said service and said virtual overlay network, comprising logging said user into a web interface suitable for triggering the assignment of an identifier to said user, as well as connecting a terminal used by said user, triggering the assignment of a terminal identifier and a virtual address for the terminal within said virtual overlay network, and storing an association between said user identifier and said terminal identifier and an association between said terminal identifier and said virtual terminal address, within said hash table;
routing data packets between said user and said service via a virtual connection established within said virtual overlay network, on the basis of said virtual addresses

According to preferred embodiments, the invention comprises one or several of the following features which may be used separately or in partial combination with each other or in total combination with each other:
the virtual address for the server and the virtual address for the terminal are determined based on the topology of said virtual overlay network and the attachment, respectively, of said server and said terminal to said virtual overlay network;
the method further comprises a step of modifying an association in said distributed hash table, if during said communication, said user or said service is no longer accessible at the same virtual address, and, a step of querying said distributed hash table by at least one node of said virtual overlay network for said routing of data packets;
if said server or said terminal changes connection to said virtual overlay network during said communication, the virtual address for said server, respectively said terminal, is determined again, and the association between the virtual address and the identifier of said server, respectively of said terminal, is modified;
if said service or said user is redeployed on a new server, respectively a new terminal, distinct from the previous terminal, the identifier of said server, respectively of said terminal, is determined again, and the association between the identifier of said service, respectively of said user, and the identifier of said server, respectively of said terminal, is modified;
the method further comprises a step) of creating and storing session information linking said user and said service, within at least one of said terminal, said server, said distributed hash table and a security token attached to a connector of said terminal.
said data packets contain a header in which at least said virtual addresses of said server and said terminal are inserted;
said header also includes said terminal identifier, said server identifier, said user identifier and said service identifier.

According to another aspect, the invention may also be implemented by a computer program comprising instructions which, when the program is executed by a computer, cause said computer to implement the method as described above.

According to a second aspect, the invention can also be implemented by equipment adapted for establishing a communication between a user using said terminal and a service implemented by at least one server, by means of a telecommunication network, comprising middleware adapted for:
registering said user with said service, comprising logging said user into a web interface suitable for triggering the assignment of an identifier to said user, as well as connecting a terminal used by said user, triggering the assignment of a terminal identifier and a virtual address for the terminal within said virtual overlay network, and storing an association between said user identifier and said terminal identifier and an association between said terminal identifier and said virtual terminal address, within said hash table;
routing data packets between said user and said service via a virtual connection established within said virtual overlay network, on the basis of said virtual addresses.

Further features and advantages of the invention will become apparent from the following description of a preferred embodiment of the invention, given by way of example and with reference to the attached drawings.

### BRIEF DESCRIPTION OF THE FIGURES

The attached drawings show the invention:

FIG. 1 schematically shows an example of . . . according to one embodiment of the invention;

FIG. 2 shows an example of a virtual overlay network as used in embodiments of the invention

FIG. 3 shows a simplified scenario according to one embodiment of the invention.

FIGS. 4a, 4b and 4c show finite automata, or state machines, according to embodiments of the invention.

### DETAILED DESCRIPTION OF EMBODIMENTS OF THE INVENTION

The invention aims to enable communication between one or more users and a service implemented, or deployed, on a server, by means of a telecommunication network.

For the sake of simplicity and clarity, the term telecommunication network is used herein to refer to any connection of network equipment, enabling remote equipment to communicate. Such a network is usually an interconnection of several sub-networks (access networks, core networks, etc.). An example of such a telecommunication network is the network commonly known as the Internet. Equipment is a physical object adapted to communicate over the telecommunication network. This can be a terminal for a user (computer, smartphone, digital tablet, connected object, etc.) or a server.

Typically, equipment comprises an operating system, which itself comprises the elements needed to implement the protocol stack suitable for communication with the telecommunication network, and one or more applications.

The applications implemented on the server enable a service to be provided to users who connect thereto. The applications implemented by the user equipment may be general-purpose or adapted to interact with the services provided by the server. Examples of such services include, but are not limited to, commercial services enabling on-line purchases, bank account management services, official administration access services (enabling tax payments, access to social security accounts, etc.), etc.

Applications implemented on user equipment can be Web browsers, allowing connection to services via HTTP or HTTPS protocols. They may also be dedicated applications, this operating mode being more common on smartphone-type devices running on Android or iOS operating systems.

Users are typically human beings using the equipment.

But some applications can behave automatically so that they themselves can be considered “users” of the services to which they are connected; for example, as in the case of machine-to-machine (M2M) communications or the Internet of Things (IoT).

Hereafter, “entities” will refer to users and services. Entities are deployed on equipment which will be referred to as a server in the case of services and a terminal in the case of users.

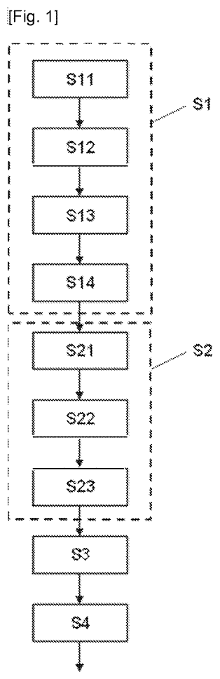

The flowchart of FIG. 1 shows a sequence of steps according to one embodiment of the invention. This particular sequence is essentially for the sake of clarity, but in a real-life situation, the order may be different, since the various players (users, services, etc.) interact independently.

According to this embodiment, a first step S1 consists in registering the service. This registration can be done with an operator who manages all or part of the various services underlying the mechanisms of the invention. In particular, this operator manages the creation and lifecycle of virtual overlay networks.

This registration can be carried out by means of a dedicated portal accessible to the service provider, for example a web portal. According to one embodiment, the service provider can specify a name for the service allowing said service to be identified by the users, for example in a way that it can be found by a search engine. It can also indicate a name for the service provider and/or any other useful information for users of the service thereof.

Registration comprises creating a virtual overlay network (step S11) for the service, over the telecommunication network. According to one embodiment, the service provider can specify a name for the virtual overlay network.

A virtual overlay network is a network formed by devices that establish connections therebetween at or above OSI Layer 3. This network and these connections can be called “virtual” because they are located over layer 2 of the OSI model (data link). Virtual connections act as virtual links between equipment. Equipment with more than one link can act as a relay (or “router”) for the flow of data packets.

The following Wikipedia pages provide further details on overlay networks:
https://fr.wikipedia.org/wiki/Réseau superposé
https://en.wikipedia.org/wiki/Overlav network

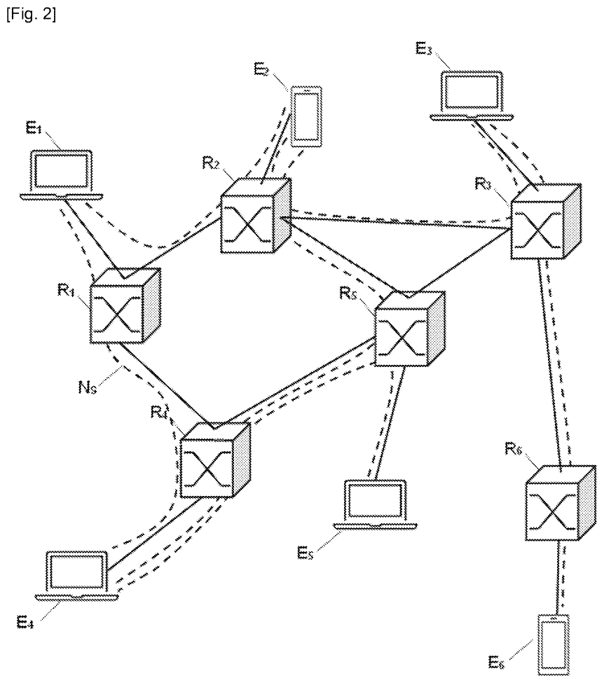

FIG. 2 shows an example of a virtual overlay network as used in implementations of the invention. According to this embodiment, the virtual overlay network Nₛ consists solely of terminal or server equipment (user or service equipment) E₁, E₂, E₃, E₄, E₅, E₆. The network equipment (switches, routers, etc.) R₁, R₂, R₃, R₄, R₅, R₆ are not part of the virtual overlay network Nₛ. Such a virtual overlay network is a peer-to-peer type network.

The links, or virtual connections, of the overlay network Nₛ are shown as dotted lines in FIG. 2. They are supported by the physical connections (shown as solid lines) connecting network equipment and terminal or server equipment, but the logical routing of data packets takes place at the level of virtual connections.

A virtual overlay network is a flexible network in that it offers an independent view of the physical infrastructure. Thus, when terminal equipment appears, disappears or connects to other network equipment (handover in mobile telephony, for example), the logical virtual network can dynamically adapt to the behavior thereof. The creation of the virtual overlay network, step S11, comprises starting up the nodes constituting this network from the nodes of the telecommunication network. Starting up a node consists in installing and/or starting specific software modules (called “virtual routers”) on server equipment located at various points in the network in order to implement the corresponding protocols and state machines allowing the mechanisms described according to the invention to operate.

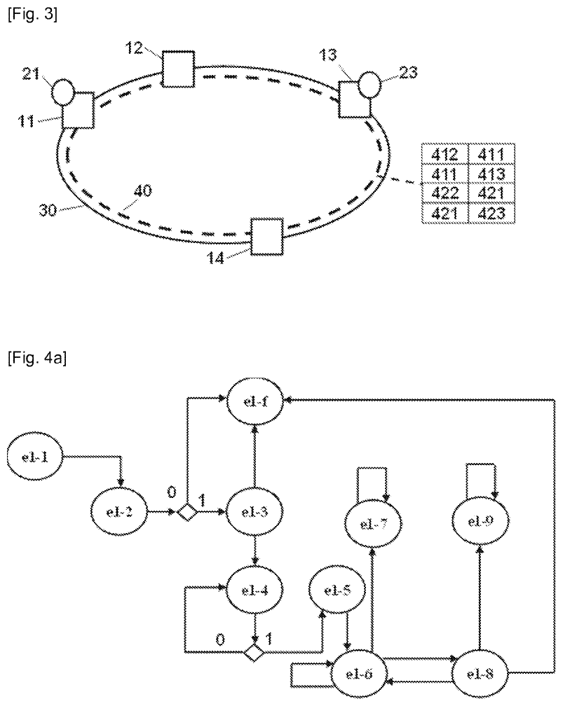

FIG. 3 shows a simplified scenario according to one embodiment of the invention. A service 21 deployed on equipment 11 is registered, resulting in the creation of a virtual overlay network 30. This overlay network is composed of terminal equipment 11, 12, 13, 14. In reality, in general, more equipment may be involved. FIG. 3 does not show the underlying telecommunication network and the constituent network equipment. However, these support the virtual overlay network 30 and allow the operation thereof.

Service registration also comprises a step S12 for assigning a service identifier 412, a server identifier and a virtual address for the server within the virtual overlay network thus created.

The service identifier is unique. According to one embodiment, a name may be associated with this identifier to allow a user to search therefor and understand what the service involves. Additional explanatory information for users may also be associated with the service identifier. It should be noted herein that this identifier is specific to the service and not to the server on which the service is implemented: thus, if a service migrates from one server to another, the identifier thereof will remain identical.

The identifier 411 of the server (or equipment) 11 on which the service 21 is deployed is also a unique identifier. If this same server belongs to several virtual networks (overlay), it can obtain as many equipment identifiers as there are networks to which it belongs.

The virtual address 413 is a unique address, within the virtual overlay network 30, allowing data packets to be routed from end to end.

This virtual address can be topological, that is, dependent on the topology of the virtual overlay network and on the position of attachment of the server to this virtual overlay network. This feature allows efficient neighbor-to-neighbor routing within the network. The very structure of the virtual address (and address space) may therefore depend on this network topology.

Additionally, since equipment may be required to change the connections thereof to the network nodes to which it is connected, the network topology and the attachment of the equipment to the network are dynamic, and the virtual address for the equipment is therefore also dynamic. Thus, if the equipment is mobile, it can disconnect from one node and connect to another node (a so-called “handover” operation). In this case, the virtual address of the equipment will evolve to take account of this topological change. The same applies in the event of accidental rupture of a connection, resulting in a new connection with a different node.

According to one embodiment, the equipment obtains the virtual address thereof from the node of the virtual overlay network to which it is connected.

The topology of the virtual overlay network can be seen as a graph, and according to one embodiment; the virtual address can be determined according to the teachings of article “Geographic routing using hyperbolic space”, by R. Kleinberg in Proceedings of the 26th IEEE INFOCOM, 2007, pp. 1902-1909.

This mechanism assigns equivalent addresses to coordinates appropriately taken from a hyperbolic plane (represented by the Poincaré disk model). The method thereof creates a greedy embedding on an addressing spanning tree. This tree is a regular tree.

However, in Kleinberg's method, the construction of the embedding requires full knowledge of the topology of the graph which must be static. This requirement arises from the fact that the degree of the tree must be set to the highest degree found in the network.

In the paper “Overlay addressing and routing system based on hyperbolic geometry” by C. Cassagnes, T. Tiendrebeogo, D. Bromberg and D. Magoni, in Proceedings of the 16th IEEE Symposium on Computers and Communications, 2011, pp. 294-301, the authors have improved Kleinberg's method in order to manage a dynamic topology that can grow and shrink over time.

This method is suitable for overlay networks. By implementing such a virtual overlay network, it becomes possible to set the degree of the addressing tree to a fixed arbitrary value while no longer having a limit on the highest degree of the network nodes, unlike the original Kleinberg method.

The arbitrarily set degree is a parameter of the virtual overlay network and corresponds to the maximum number of virtual addresses that a given node can allocate.

Note that, according to this implementation, virtual addresses are sufficient to route data packets at each hop in the network, without the need for routing tables therewithin. It therefore enables efficient deployment in the nodes without monopolizing the memory resources thereof.

According to one embodiment of the invention, this step of registering S1 the service comprises security steps which condition the steps of creating S11 a virtual overlay network, and assigning S12 a service identifier 412, a server identifier 411 and a virtual address for the server 413 within this virtual overlay network.

These security steps may comprise the creation of a certificate C21 for the service 21.

According to one embodiment, when registering the service 21 with the operator, the service provider generates a pair of cryptographic keys comprising a public key and a private key, and provides the operator with this public key. This can be done at the same time as providing the name of the virtual overlay network and the name of the service, for example.

The certificate can then be created and sent to the service provider. It is signed by the public key of the operator, which acts as the certification authority.

According to one embodiment, this certificate may contain:
the service identifier,
the name of the service
the name of the service provider
the public key for the service

This certificate can be used to secure all communications between the equipment (herein the server) 11 on which the service 21 is deployed and the users located in the virtual overlay network 30.

In a similar way, a user has a certificate assigned and signed by the service provider to authenticate his identity (see below). When a secure connection is established, the service (server-side) and user (client-side) certificates are jointly used to exchange signed ephemeral values allowing each to generate a common secret key using a Diffie-Hellman-type algorithm (for example, with an elliptic curve-ECDHE). This key, the so-called “pre-master secret”, is used to derive so-called session keys, which are used to symmetrically encrypt all traffic exchanged within the connection (typically using an AES-GCM type algorithm, for example).

The step S1 of registering the service also comprises a step S13 of storing an association between the service identifier 412 and the server identifier 411, and an association between the server identifier 411 and the virtual address 413 for the server, within a distributed hash table 40 on nodes of said virtual overlay network 30. Thus, two distinct associations can be stored in the hash table, each corresponding to a row in the following table:

TABLE 1

| Key | Value |
|---|---|
| Service identifier 412 | Server identifier 411 |
| Server identifier 411 | Virtual address for the server 413 |

These associations are shown in FIG. 3, along with those relating to users, in the form of a table. However, these associations can be stored independently in different nodes of the distributed hash table 40. (In the figure, the associations are not associated with a particular node but with the hash table in general).

A DHT (for Distributed Hash Table) is a technology allowing a hash table to be implemented in a distributed peer-to-peer system. A hash table is functionally identical to a directory for storing pairs (key, value).

A peer-to-peer network is a network composed of separate nodes (corresponding to physical or virtual machines) running identical instances of an application. Each node therefore has identical programmed behavior: each node can interact with any other node and there are no specific roles or hierarchies.

The distributed hash table enables pairs (key, value) to be stored efficiently on a set of nodes. Each piece of data can be accessed by the key thereof, through a query making an average of O (log n) hops in the network, where n is the number of nodes making up the DHT.

The key corresponds to the application of a hash function which projects the space of values that it can take to an addressing space of the nodes in the distributed hash table.

In this case, for each service:
a first record in the distributed hash table may correspond to the first row in the above table and correspond to the value of the server identifier 411 associated with a key formed from the service identifier 412, and,
a second record may correspond to the second row of the table and correspond to the value of the virtual address for the server 413 associated with a key formed from the server identifier 411.

This distributed hash table is supported by all or some of the nodes in the virtual overlay network 30. According to one embodiment, all the nodes of this network are members of the distributed hash table.

According to one embodiment, the distributed hash table is secured by redundant storage of the same pair (key, value) on at least two distinct nodes.

If the service can no longer be accessed at the same virtual address, a new virtual address must at least be determined and the corresponding association(s) must be modified in the distributed hash table.

At least two situations may arise during a communication:
the server changes attachment to the virtual network overlay,
the service is redeployed on a different server.

If the service 21 is to be redeployed on a new piece of equipment 12 (distinct from the previous one), a new server ID will be determined for this service. A node in the virtual overlay network (which is informed of this redeployment) therefore initiates the update for the association stored in the distributed hash table, that is:
the association between the service identifier and the identifier for the new server.

As will be explained below, a node that has to route a data packet may be informed that the equipment that previously supported the service is no longer accessible or no longer supports this service. In this case, knowing the service identifier, it can query the distributed hash table and obtain in response the value of the identifier for the new equipment now supporting the service. Then, a second request, using this updated equipment identifier, allows it to retrieve the virtual address of this equipment, and to route the data packet.

If the same equipment 11 changes its connection to the virtual overlay network, a new virtual address must optionally be determined to reflect this topological change. In this case, a node of the virtual overlay network (which is informed of this change) therefore initiates the update for the association between the equipment identifier and the virtual address for the equipment in the distributed hash table.

As will be explained below, a node that has to route a data packet can be informed that the equipment supporting the service is similarly no longer connected and has optionally changed address. In this case, knowing the equipment identifier, it can query the distributed hash table and obtain in response the value of the virtual address for the equipment, and thus route the data packet. In this situation, therefore, only one DHT request is needed.

Step S2 consists of a registering a user with the service.

In the general case where several users register with the same service, this step S2 is iterated for each of these users. This step S2 typically follows step S1 of registering the service.

This registration first comprises, in a sub-step S11, logging the user onto a web interface (or portal) or the like.

This interface can be managed by the operator who manages all or part of the various functions underlying the mechanisms of the invention.

It can allow the user to create an account and to obtain access to the various services deployed and previously registered with this operator. Once registered, the user can access available services either by prior knowledge of the names or identifiers thereof, or by using a search engine accessible from this portal, or by using a list, optionally hierarchical, of available services, or by still other means.

Creating an account allows the user to log into the interface, which is then adapted to trigger a sub-step of assigning a user identifier, 422.

In a sub-step S22, the user 23 logs in via equipment 13, which triggers the assignment of an equipment identifier 421 and a virtual address for the equipment 423 within said virtual overlay network.

According to one embodiment, the equipment 11 can connect to a node of the virtual overlay network. This node, or else a peer in the overlay network, may then be responsible for this assignment.

These steps for registering and assigning virtual identifiers and addresses are similar, mutatis mutandis, to those previously explained for the service and the server on which it is deployed. Certain aspects and implementation details will therefore not be repeated herein.

In particular, in the same way as for the service, the user identifier is unique and allows the user to be unequivocally identified within the network. It is specific to the user himself and not to the equipment that said user may be using. Thus, if the user changes equipment (for example, leaves home and switches from his computer to a mobile telecommunication terminal), his user ID will remain the same.

The identifier 421 for the equipment 13 used by the user 23 is also a unique identifier. If this equipment belongs to several virtual overlay networks, said equipment can obtain as many equipment identifiers as there are networks to which said equipment belongs.

The virtual address 423 for the equipment 13 is a unique address within the virtual overlay network 30, which enables data packets to be routed end-to-end (that is, between the user and the service).

This virtual address is of the same nature and structured in the same way as the server address, since they are both part of the same addressing space and are subject to the same algorithms for assigning and routing data packets. As set forth above, the virtual address is a topological and dynamic address: it is therefore subject to the attachment of the equipment 13 to the telecommunication network. It is therefore determined based on the topology of the virtual overlay network and on the attachment of the equipment to this virtual overlay network.

When this attachment changes over time (for example, following a handover from a WLAN access point to a cellular base station), a new virtual address will be assigned to take account of the change in the underlying topological position of the equipment.

According to one embodiment of the invention, this user registration step S2 comprises security steps which condition the steps of assigning a user identifier 422, an equipment identifier 421 and a virtual address 423 for the equipment within this virtual overlay network.

These security steps may comprise the creation of a certificate C23 for the user 23. According to one embodiment, when registering the user 23 with the operator, the user generates a pair of cryptographic keys comprising a public key and a private key, and provides the operator with this public key.

The certificate can then be created and sent to the user, signed by the public key of the operator acting as certification authority.

According to one embodiment, this certificate may contain:
the user identifier,
the name of the user,
the public key for the user.

This certificate can be used to secure all communications between the equipment 13 used by the user 23 and the virtual overlay network 30 containing the server supporting the desired service.

Indeed, a service has a certificate assigned and signed by the service provider or operator in order to authenticate the identity thereof (see above). When a secure connection is established, the service (server-side) and user (client-side) certificates are jointly used to exchange signed ephemeral values allowing each to generate a common secret key using a Diffie-Hellman-type algorithm (for example, with an elliptic curve-ECDHE). This key, the so-called “pre-master secret”, is used to derive so-called session keys, which are used to symmetrically encrypt all traffic exchanged within the connection (typically using an AES-GCM type algorithm, for example).

The user registration step S2 also comprises a step S23 of storing within the distributed hash table:
a first association between the user identifier 422 and the equipment identifier 421, and
a second association between the equipment identifier 421 and the virtual address for the equipment 423.

As for the service, two distinct associations can be stored within the distributed hash table, for each user. Each association corresponds to a row in the table below, given as an illustrative example:

TABLE 2

| Key | Value |
|---|---|
| User identifier 422 | Equipment identifier 421 |
| Equipment identifier 421 | Virtual address of the equipment 423 |

If a user changes equipment, a new equipment identifier is determined. A node in the virtual overlay network (informed of this change) therefore initiates the update for the association stored in the distributed hash table, that is, the association between the user identifier and the new terminal identifier.

Furthermore, a node that has to route a data packet may be informed that the destination equipment (previously used by the user) is no longer accessible or is no longer used by the user. In this case, knowing the user identifier 422, the node can query the distributed hash table and obtain the value of the equipment identifier 421 in response. Then, using this equipment identifier, a second request is made to obtain the virtual address 423 and thus allow the data packet to be routed to the new destination.

If the same equipment 13 changes its connection and optionally its point of attachment to the virtual overlay network, a new virtual address must be determined to reflect this topological change.

In this case, a node of the virtual overlay network (which is informed of this change) initiates the update for the association between the equipment identifier/virtual address of the equipment within the distributed hash table.

A node routing a data packet can be informed that the equipment used by the recipient user is no longer similarly connected. In this case, knowing the equipment identifier, it can perform a single query of the distributed hash table and obtain in response the value of the virtual address for the equipment, and thus route the data packet. A single request is herein therefore necessary.

According to one embodiment of the invention, the method also comprises a step S3 of creating and storing session information linking the user 23 and the service 21.

The session can be defined as a container that stores all the information needed to carry out the communication during the lifetime thereof. This session is implemented in all the equipment of participants in communication (for example those supporting the service 21 and one or more service users 23), but in addition, it can also be securely stored in certain virtual network equipment (i.e. on virtual routers) or even on hardware security tokens (e.g. USB key, SD card, smart card, etc.) attached to a connector of said terminal, to ensure the reliability thereof in the event of equipment failure. A session is the link between the entities (services, users), the equipment and the applications involved in communication. A session has a unique identifier in the virtual network in which it is located. This identifier can be released at the end of the session.

Session information can be used when a member of the communication is disconnected and wishes to reconnect: session information can be used to store the connection status at the time of disconnection and to allow reconnection.

Similarly, if all members have been accidentally disconnected, the session information can also allow all members to be reconnected if the session was stored on certain nodes of the network that remained operational (for example, a virtual router, see above), or else if it was stored on a security token (see above). This session information can be stored in the distributed hash table.

As set forth above, the method also comprises a step S4 of routing data packets between the user 23 and the service 21 via a virtual connection established within said virtual overlay network, on the basis of the respective virtual addresses.

The virtual addresses for the source and recipient (or recipients in the case of multicast transmission) can be inserted in a data packet header.

According to one embodiment, in order to facilitate the routing of a data packet when the recipient is no longer accessible at the virtual address indicated, the equipment identifiers (e.g., terminal, server) and entity identifiers (e.g., user, service) can also be inserted in this header.

In the general case where several virtual networks coexist over a single network, it is also possible to insert the identifier of this virtual overlay network. The virtual addresses only make sense in the corresponding virtual overlay network. The tables below show an example data packet according to one embodiment of the invention:

TABLE 3

| | | | | | | |
|---|---|---|---|---|---|---|
| Ethernet | IP | TCP | INV | HTTP | Data | Ethernet check |
| | | | | | | sequence |

The first table shows a data packet. Typically, this comprises several headers corresponding to a protocol stack. This thus includes headers corresponding to the Ethernet™, IP, TCP and HTTP protocols.

The “Data” field corresponds to the data transmitted (optionally comprising other headers corresponding to higher-level protocols than HTTP).

The “Ethernet Frame Check Sequence” (FCS) field corresponds to a checksum based on the Cyclic Redundancy Code (CRC) used by the Ethernet protocol to detect transmission errors in the frame.

The “INV” field corresponds to a specific header according to one embodiment of the invention. This corresponds to a protocol between the transport protocol (for example TCP or UDP) and the application protocol (for example HTTP).

This “INV” field is detailed in the following table:

TABLE 4

| | | | | | | | | |
|---|---|---|---|---|---|---|---|---|
| Source | Recip. | VN ID | Source | Recip. | Session ID | Source | Recip. | etc. |
| VA | VA | | Eq. ID | Eq. ID | | Ent. ID | Ent. ID | |

A “Source VA” field corresponds to the source virtual address (for example 423, for a packet transmitted from the user 23 to the service 13).

A “Recip. VA” field corresponds to the recipient virtual address (for example 413). An “VN ID” field contains an identifier for the virtual overlay network.

A “Source Eq. ID” field corresponds to the identifier for the source equipment (terminal, respectively server), (for example identifier 421).

A “Recip. Eq. ID” field corresponds to the identifier for the recipient equipment (terminal, respectively server), (for example identifier 411) A “Session ID” field may correspond to the session identifier.

A “Source Ent. ID” field corresponds to the identifier for the user, respectively service, source (for example identifier 412).

A “Recip. Ent. ID” field corresponds to the identifier for the user, respectively service, recipient (for example identifier 422).

Even other fields, such as “etc.”, can be included in this header.

As set forth above, the virtual addresses may, according to one embodiment, be topological. This means that each node can route a packet to the next node on the path leading to the destination node, without even needing a routing table. Gradually, the data packet can thus be transmitted from the source to the destination.

If a node in the path is informed that: either the virtual address is no longer valid, or the recipient (that is, the user or service) no longer corresponds to this virtual address, the node can consult the other fields in the “INV” header in order to deduce the new address thereof.

As set forth above, depending on the case, the “Recip. Eq ID” and “Recip. Ent ID” fields can be used to recover the actual virtual address by querying the distributed hash table which stores the various associations between these identifiers and virtual addresses.

According to one embodiment, the equipment has software modules to implement the relevant parts of the steps described above. In particular, these software modules, known as “middleware”, provide the interface between the virtual overlay network 30 and the applications running on the equipment (terminals and servers). For example, on user equipment, applications such as web browsers, video-conferencing applications, etc., can be installed and run in order to establish a connection with a service (also instantiated by one or more applications) deployed on a server. On the server deploying the service, the applications can comprise a Web server, a videoconferencing server, etc.

On both the user and the service side, middleware can, if required, manage all aspects specific to the invention so that the applications do not have to be modified.

Thus, a conventional Web server can be used, as well as a conventional videoconferencing application.

Applications contain modules (libraries) implementing the interfaces of the telecommunication protocol stacks (TCP/IP) located in the operating systems.

According to one embodiment, these modules are modified to use an API for routing calls to the protocol stack towards the middleware, which can also run on the equipment. In this case, the applications must be modified. Communication with middleware can typically be implemented using Inter-Process Communication (IPC) calls.

Middleware can use the API of a TLS library (e.g. OpenSSL, GnuTLS, mbedTLS, etc.) in order to transport data flows to the nodes of the virtual overlay network. The TLS (Transport Layer Security) mechanism, and its predecessor SSL (Secure Sockets Layer), are protocols for securing exchanges over computer networks, particularly the Internet. The SSL protocol was originally developed by Netscape Communications Corporation for its browser. The IETF standards organization has continued the development thereof, renaming it Transport Layer Security (TLS). SSL/TLS is sometimes used to refer to both SSL and TLS.

The TLS library makes system calls in order to create secure sockets, enabling said library to connect to nodes in the virtual network.

According to one embodiment, data packets can thus be routed securely using a session key (or “master secret” in TLS protocol terminology) determined from the service and user certificates (notably by exchanging signed ephemeral values to generate a so-called “pre-master secret” key). These aspects are described in the TLS protocol specifications, or, for example, more briefly, on the Wikipedia page:
https://fr.wikipedia.org/wiki/Transport Layer Security

If the middleware is implemented as a service running in the background without a user interface (i.e. Unix daemon or Windows service), then a manager application is needed to control and monitor the middleware. This application communicates with the middleware via IPC calls.

Otherwise, the management application is not required and can be merged into the middleware itself.

As can be seen, the entities can communicate in two different ways: via Web interfaces or portals during the registration stages notably in order to obtain entity identifiers and the corresponding certificates, and then via middleware for subsequent steps involving the transmission of data packets within the application domain. This therefore means that communication is first external to the virtual network, then internal thereto.

All the mechanisms and corresponding middleware modules can be described by Finite State Machines (FSM).

The middleware located on each piece of equipment (e.g. terminals, servers) and the software located on the nodes of the virtual overlay network (i.e. virtual routers) can implement one or more state machines. It should be recalled that, in a peer-to-peer network, the nodes are the equipment supporting the virtual routers and the equipment of the various users and services.

According to one embodiment of the invention, several state machines are implemented, corresponding to certain aspects of the mechanisms described above.

The state machines operate asynchronously in parallel, but interact, and their specific entanglement, according to this embodiment, provides the general functionality of the invention.

A state machine, or finite automaton, is a mathematical model of computation, used in numerous circumstances, from computer program and sequential logic circuit design to applications in communication protocols, including process control, linguistics and even biology. A finite automaton is an abstract mathematical construct that has a finite number of states, but can only be in one state at any one time. The switch from one state to another is activated by an event or a condition, and is called a “transition”. A particular automaton is defined by the set of states and the set of transitions thereof.

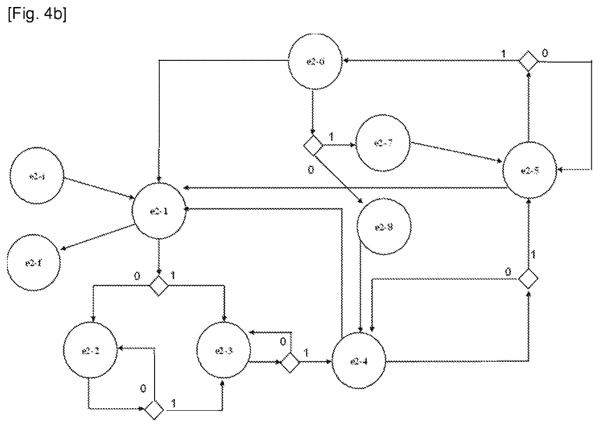

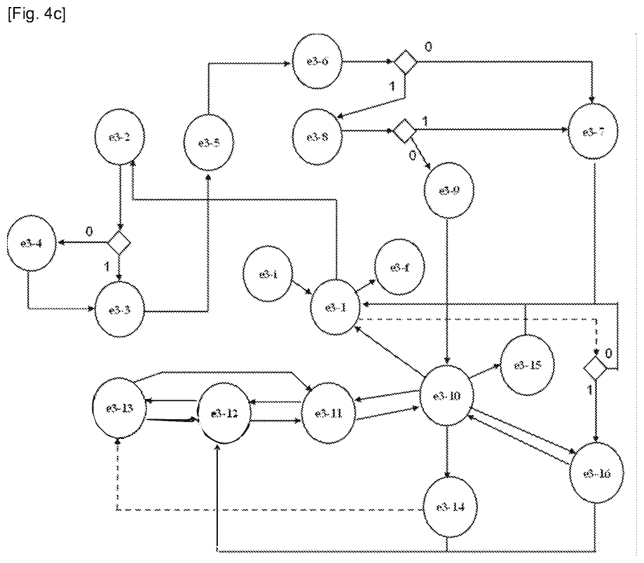

FIG. 4a shows a first state machine according to one embodiment of the invention. This state machine is implemented by the equipment (including by the server in the case of a service), for example in the form of middleware.

Initially, an entity (that is, a user or a service) wanting to join a virtual overlay network registers with the network operator in order to be assigned a unique identifier (for a user or service), and a unique name associated with this identifier. This step corresponds to state e1-1.

Once these identifiers and names have been determined, the automaton enters state e1-2, in which the entity generates a public-private key pair. The name and public key are inserted in a certificate signed by the certification authority of the operator.

If the operator validates this record (transition “1”), said operator delivers a certificate to the entity, in state e1-3.

Otherwise (transition “0”), the automaton terminates in a final state e1-f.

In state e1-4, the entity can install middleware and configure it to connect to the virtual overlay network. The entity selects a name and identifier for the equipment thereof and submits the information to the virtual overlay network via a query to the distributed hash table.

If the name and identifier are available (transition “1”), the automaton can enter state e1-5, in which the entity generates a public-private key pair, then creates a certificate for the equipment thereof. In the next state e1-6, the automaton signs said certificate with the private key for the entity thereof.

If the name and/or identity is not available (transition “0”), the automaton will loop back to state e1-4 to request a name and identifier again.

The entity (via the associated middleware) sends a request to the distributed hash table in order to store the association between the entity identifier and the equipment identifier (state e1-7)

When the entity changes equipment, this association is updated (loop to state e1-7 for storing the association). As set forth above, storing this association allows the network to know at all times which equipment a given entity is located on.

Note that states e1-4 to e1-7 are included in state e3-4 of FIG. 4c which describes equipment addressing management.

When the equipment obtains a virtual address in the virtual overlay network, the automaton thereof switches to state e1-8 (corresponding to state e3-5 in FIG. 4c).

When the equipment receives a virtual address, said equipment sends a request to the distributed hash table to store the association between the identifier and virtual address thereof (state e1-9).

When the equipment moves and thus changes its attachment to the virtual overlay network, the virtual address thereof also changes and this association is updated (loop on state e1-9). Thus, the network knows where the equipment is located in the network at all times.

FIG. 4b shows a simplified automaton that manages the states assumed by the equipment.

Initially, the middleware is started on the equipment. Said middleware checks that it can access the underlying network, that is, the Internet, for example (initial state e2-i). If the equipment has network interfaces with access to the Internet, the automaton switches to state e2-1.

The middleware implementing the automaton then checks whether it has a list of peers in the virtual overlay network, that is, a list of equipment supporting virtual routers (nodes) already in the network.

If yes (transition “1”), the equipment contacts said peers and determines the best peer to connect to (state e2-3). The selection criteria may be the available throughput, latency (or jitter), connection stability, etc. Said equipment then sends a connection request thereto. If the request is refused, the equipment sends a request to a second piece of equipment on the list, and so on. According to some embodiments, note that it is possible to connect to several peers in order to increase the reliability of the maintenance thereof in the virtual overlay network. The peer(s) to which the equipment is directly connected are called neighbors.

If not (transition “0”), the equipment addresses an out-of-band bootstrap server, which can send said equipment an appropriate list of potential neighboring peers (state e2-2), in order to switch to the previously described state e2-3 (transition “1”). Until it receives this list, said equipment can loop back to state e2-2 (transition “0”). Once connected to one or more neighboring pieces of equipment located in the virtual overlay network (state e2-4), the equipment then requests a virtual address from the best neighbor according to criteria that may be similar to those set forth above.

If the equipment receives a virtual address (transition “1”), the automaton switches to state e2-5. The neighbor who gave said equipment an address is called a parent. The equipment then makes the request to the distributed hash table described in state e1-9, in order to store the association between the equipment identifier thereof and the virtual address assigned to said equipment.

If no address is received (transition “0”), the automaton returns to state e2-4 and asks the next best neighbor, and so on. If none of the neighbors of said equipment can provide it with an address, then the equipment connects to additional peers until it finds a neighboring peer capable of providing it with an address.

When the equipment loses the connection to the parent thereof (transition “1”), said equipment becomes an “orphan” and the automaton enters state e2-6. As long as the connection is not lost, the automaton remains in state e2-5 (transition “0”).

In state e2-6, the equipment tries to reconnect to its parent.

If successful, the automaton returns to state e2-5.

Otherwise, the equipment tries to request an address from one of the ascendants to which said equipment is connected. It can also try to connect to new ascendants in order to ask them for an address.

According to the topology-based addressing mechanism set forth above, nodes with an address included in that of the node (or equipment) in question can be referred to as “ascendant” nodes. Similarly, the descendants of a node in the topology are the nodes that have an address derived from the node in question (that is, whose address comprises that of the node in question).

If it successfully connects to an ascendant (transition “1”), the automaton enters state e2-7: it broadcasts an address update message to all of its descendants, then enters state e2-5.

If it fails, it switches to state e2-8, wherein it broadcasts an address purge message to all its descendants (whose respective automata therefore switch to state e2-6), then it switches back to state e2-4.

The equipment can leave the virtual overlay network and return to state e2-1 at any time.

FIG. 4c shows a third automaton, or state machine, for sessions and interactions. Herein, an interaction is an application action executed within a given session. An example action might be a voice call between two entities in the session. An interaction can take the form of one or more application data streams, for example a signaling stream (according to the SIP protocol, for example) and two voice data streams (according to the RTP protocol, for example). Each interaction can have its own unique and unequivocal identifier within the session hosting it.

Initially, the automaton is in an initial state e3-i. It enters state e3-1, corresponding to the start-up of the middleware on the equipment and the attachment thereof to one or more virtual overlay networks. It is assumed that (due to the processes associated with the automata previously described) in this state, one or more entities are defined and valid in each virtual overlay network. Similarly, at least one piece of equipment is defined and valid in each virtual overlay network.

It is assumed that an entity (user or service), through an application or middleware, creates a session and assigns a session identifier thereto, or else receives an invitation message to participate in a session (associated with a session identifier) and accepts it. The automaton then enters state e3-2.

The automaton checks whether the middleware has the certificate from the root certification authority for the virtual overlay network to which it belongs.

If it does not have said certificate (transition “0”), the automaton enters state e3-4 to make a request to retrieve this certificate.

When said automaton has this certificate (transition “1” or following state e3-4), it changes to state e3-3. Then, in state e3-5, it adds one or more recipients to the session.

In state e3-6, the automaton sends a request to the distributed hash table to retrieve the identifier, name and address of the equipment on which the recipient entity is located.

If the automaton does not receive the entity and equipment certificates for the recipient (transition “0”), the automaton enters state e3-7, corresponding to closing the session.

If certificates are received (transition “1”), the middleware checks the validity thereof in state e3-8.

If the certificates are invalid (transition “0”), the automaton enters state e3-7, which closes the session.

If they are valid (transition “1”), the middleware can generate a shared session key to encrypt data exchanges (state e3-9), then the session switches to the “active” state, e3-10.

Once the session is active, the application or middleware can create one or more interactions, in state e3-11. An interaction controls one or more flows carrying data sent/received by application protocols (SIP, RTP, etc.) running in the application. If the middleware creates the interaction, said middleware will then launch the execution of an application to handle these data flows (i.e. this application implements the application protocols for these flows). An interaction has the application identifier as well as the identifiers of the flows controlled by said interaction.

A given interaction can be started (state e3-12), paused (state e3-13) and stopped (state e3-11).

Note that a session can also be paused (state e3-14). In this case, all interactions belonging to this session are also paused.

A session can be transferred to another piece of equipment. This other equipment must be started up and must run the middleware in order to enter state e3-1. It then tries to recover the session located on the original equipment. If the equipment succeeds (transition “1”), it can switch to state e3-16. Otherwise (transition “0”), it remains in state e3-1.

If the equipment supporting the session fails, the session is lost (state e3-15) if a security token is not used (see above). It is then necessary to use another piece of equipment and query the distributed hash table or else the recipient to recover the lost session. If a security token was used on the faulty equipment, it suffices to plug it into a new piece of equipment in order to recover the session. The use of a token is optional but useful in the event of support equipment failure.

Note that storing session data in the distributed hash table is optional. This can be carried out in state e3-10, according to one embodiment.

The automata shown in FIGS. 4a, 4b and 4c are examples of how the principles of the invention can be implemented, but other embodiments are of course possible. These automata are notably susceptible to numerous alternatives. It should also be noted that the representations thereof in the figures are simplified and that it is possible to divide certain states into several states, or, on the contrary, to group some of said states together: in some cases, in fact, the choice of states may be arbitrary or driven by considerations distinct from those of the invention.

As set forth above, these automata can be implemented, according to the embodiments of the invention, by one or more modules of a middleware installed and executed on the equipment taking part in the communication or even, with regard to virtual routers, by hardware equipment containing chips with electronic circuits specific to these automata (i.e. ASIC chips) or with programmable electronic circuits implementing these automata (i.e. FPGA chips).

In particular, the equipment is therefore suitable for deploying such middleware, as well as applications, for both servers (i.e. service equipment) and terminals (i.e. user equipment), as set forth above.

This equipment notably has the technical communication means to allow a connection for the transmission of information via a telecommunication network, and also has the circuitry (in particular at least one processor and a memory component for storing computer instructions) suitable for deploying an operating system, software modules implementing the protocol stacks, middleware and various applications.

Such equipment can comprise mobile telecommunication terminals, notably of the “smartphone” type, laptops or desktop computers, tablets, connected objects of all types, and so on.

The communication means can allow connection to different types of access networks: cellular networks, especially 4^{th} or 5^{th} generation, local wireless networks, notably WIFI, or proximity networks such as Bluetooth or NFC (Near Field Communication), and so on.

Thus, according to its embodiments, the invention makes it possible to simultaneously couple the security (authentication, integrity and confidentiality) of data flows exchanged between applications and the mobility of equipment and entities.

Application connections based on perennial user and service identifiers can be maintained when the underlying connections are broken and then re-established, thereby resulting in IP address changes.

In addition, the certificates associated with these identifiers are managed within the virtual overlay network and the private keys associated with these identifiers are managed and stored by the user in a wallet integrated into the middleware or else stored in a hardware security token. These elements therefore respect the principles of self-sovereign identity whereby the user retains and manages his private keys. Additionally, within the virtual network, communications are autonomous: they do not use external services (in particular, the use of PKI or use of DNS are not required for the invention to work).

Of course, the present invention is not limited to the examples and embodiment described and shown, but is defined by the claims. In particular, it is susceptible to numerous variants accessible to the skilled artisan.

1. A method for establishing communication between a user and a service, implemented by at least one server, by means of a telecommunication network comprising nodes, characterized in that it comprises:
registering said service comprising creating a virtual overlay network for said service, over said telecommunication network, said virtual network being composed of nodes from the nodes of the telecommunication network, assigning a service identifier, a server identifier and a virtual address for the server within said virtual overlay network, and storing an association between said service identifier and said server identifier and an association between said server identifier and said virtual address for the server, within a hash table distributed over nodes of said virtual overlay network;
registering said user with said service and said virtual overlay network, comprising logging said user into a web interface suitable for triggering the assignment of an identifier to said user, as well as connecting a terminal used by said user triggering the assignment of a terminal identifier and a virtual address of the terminal within said virtual overlay network, and storing an association between said user identifier and said terminal identifier and an association between said terminal identifier and said virtual terminal address, within said hash table;
routing data packets between said user and said service via a virtual connection established within said virtual overlay network, on the basis of said virtual addresses.

2. The method according to the preceding claim 1, wherein the virtual address for the server and the virtual address for the terminal are determined based on the topology of said virtual overlay network and the attachment, respectively, of said server and said terminal to said virtual overlay network.

3. The method according to the preceding claim 2, further comprising:
a step of modifying an association in said distributed hash table, if during said communication, said user or said service is no longer accessible at the same virtual address, and,
a step of querying said distributed hash table by at least one node of said virtual overlay network for said data packet routing.

4. The method according to claim 3 wherein if said server or said terminal changes attachment to said virtual overlay network during said communication, the virtual address for said server, respectively said terminal, is determined again, and the association between the virtual address and the identifier of said server, respectively of said terminal, is modified.

5. The method according to claim 3, wherein if said service or said user is redeployed on a new server, respectively a new terminal, distinct from the previous one, the identifier for said server, respectively for said terminal, is determined again, and the association between the identifier for said service, respectively for said user, and the identifier for said server, respectively for said terminal, is modified.

6. The method according claim 1 further comprising a step (S3) of creating and storing session information linking said user and said service, within at least one of said terminal, said server, said distributed hash table and a security token attached to a connector of said terminal.

7. The method according claim 1, wherein said data packets contain a header in which at least said virtual addresses of said server and said terminal are inserted.

8. The method according to the preceding claim 7, wherein said header also comprises said terminal identifier, said server identifier, said user identifier and said service identifier.

9. A computer program product comprising instructions which, when the program is executed by a computer, cause said computer to implement the method according to one of the preceding claims.

10. A terminal suitable for establishing communication between a user using said terminal and a service implemented by at least one server by means of a communication network comprising nodes, characterized in that, the communication is established by means of a virtual overlay network, created upon registering said service over said communication network, and composed of nodes from the nodes of said telecommunication network, said method comprises a middleware suitable for:
registering said user with said service, comprising logging said user into a web interface suitable for triggering the assignment of an identifier to said user, as well as connecting the terminal triggering the assignment of an identifier for the terminal and a virtual address for the terminal within said virtual overlay network, and storing an association between said user identifier and said terminal identifier and an association between said terminal identifier and said virtual terminal address, within said hash table distributed over the nodes of said virtual overlay network;
routing data packets between said user and said service via a virtual connection established within said virtual overlay network, on the basis of said virtual addresses.

11. A server for implementing a service, adapted for establishing communication between a user and said service, by means of a communication network comprising nodes, characterized in that it comprises middleware adapted for:
registering said service, comprising creating a virtual overlay network for said service, over said telecommunication network, said virtual network being composed of nodes from the nodes of said telecommunication network, assigning a service identifier, a server identifier and a server virtual address within said virtual overlay network, and storing an association between said service identifier and said server identifier and an association between said server identifier and said server virtual address, within a hash table distributed over nodes of said virtual overlay network;
routing data packets between said user and said service via a virtual connection established within said virtual overlay network, on the basis of said virtual addresses.
